(19) United States
(12) Patent Application Publication
(10) Pub. No.: US 2007/0028077 A1
(43) Pub. Date: Feb. 1, 2007

(54) Pipeline processor, and method for automatically designing a pipeline processor

(75) Inventors: Takanori Tamai, Kawasaki-shi (JP); Takashi Miyamori, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/492,937

(22) Filed: Jul. 26, 2006

(30) Foreign Application Priority Data
Jul. 27, 2005 (JP) 2005-217789

(51) Int. Cl. G06F 9/40

(52) U.S. Cl. 712/209; 712/218

(57) ABSTRACT

A pipeline processor including an instruction decode unit configured to decode fetched instruction, and to selectively issue one of a user customizable instruction defined by a user and a core instruction. A core instruction execution unit is configured to execute the issued core instruction. A user customizable instruction unit is configured to execute the issued user customizable instruction. A reorder buffer is configured to temporarily store instruction execution results of the core instruction execution unit and the user customizable instruction unit, and to reorder the instruction execution results in accordance with an order in which the core instruction and the user customizable instruction were issued.

### CROSS REFERENCE TO RELATED APPLICATION AND INCORPORATION BY REFERENCE

This application is based upon and claims the benefit of priority from prior Japanese Patent Application P2005-217789 filed on Jul. 27, 2005; the entire contents of which are incorporated by reference herein.

### BACKGROUND OF THE INVENTION

1. Field of the Invention

The present invention relates to a pipeline processor capable of extending instructions, and a method for automatically designing the pipeline processor.

2. Description of the Related Art

A reduced instruction set computer (RISC) and a complex instruction set computer (CISC) has been known as processor architecture. By simplifying instructions, the RISC processor implements the pipeline process, the process commencing the processing of the subsequent instruction before the processing of the previous instruction has completed. The basic pipeline process executes each stage independently, those stages being: an instruction fetch stage (hereinafter referred to as “F stage”), an instruction decode stage (hereinafter referred to as “D stage”), an instruction execution stage (hereinafter referred to as “E stage”), and a write back stage (hereinafter referred to as “W stage”).

When a pipeline processor executes an instruction, it is necessary to resolve any hazard caused by the instruction and processor architecture. There are two types of hazard in the typical pipeline processor: data hazard and structural hazard. There is also the term “control hazard,” but this is included in the general sense of data hazard. Data hazard is hazard originating from the difference of two cycles, those cycles being: the cycle where information necessary for the execution of an instruction is read from the register, and the cycle where the results of the execution are written to the register. There are various types of structural hazards, depending upon the structure of the pipeline processor. Basically, however, it is a hazard caused by insufficient hardware resources.

The pipeline processor reads the register information in the D stage, and writes to the register in the W stage. Here, it is assumed that instruction A, which stores process results in register 0, and instruction B, which uses the register 0. When the instruction A exists in the E stage, the subsequent instruction B exists in the D stage. When the instruction A cannot reach W stage, the results for the instruction A cannot be obtained, even if instruction B reads the register 0. This type of hazard is called a read after write hazard” (hereafter referred to as “RAW hazard”). In contrast, there is a “write after write hazard” (hereafter referred to as “WAW hazard”). The hazard overwrites the next instruction after the first instruction for a register has been written.

Structural hazard occurs in events such as two requests for readout from a memory device that has only one readout port. In this event, since the memory cannot process more than one demand at a time, it is necessary for one request or the other to wait. A solution is possible when using memory capable of simultaneously processing two requests for a readout. However, as the hardware scale increases, this can cause a decrease in operation speed.

To resolve data hazard, “stall” or “interlock” can halt the succeeding instruction executions. As for other resolutions, there is one method that sets the hardware to send data to the succeeding instructions before the preceding instructions reach W Stage. This is known as data “bypass” or “forwarding”. Data hazard of a pipeline processor is typically resolved by a combination of stall and data bypass.

For efficient instruction execution, it is necessary to control optimum stall and bypass in the pipeline structure. However, this control depends greatly on the pipeline structure. For example, the control of stall and bypass meant to execute efficient instructions becomes unusually complex (1) when there are multiple pipelines for instruction execution, (2) each pipeline has a different number of execution stages, and (3) in a complex processor that changes the number of execution stages depending on the operation data.

Alternatively, as a way where the user expands optional instructions, there is a known method that connects the device (hereinafter referred to as “user customizable instruction unit”) executing instructions defined by the user (hereinafter referred to as “user customizable instruction”) to the processor core.

With a classical pipeline processor, when the number of execution stages for the user customizable instruction is longer than the execution pipelines in the processor core, an exception may occur during the following stages of the pipeline. In this event, until it has been confirmed whether or not there is an exception, instructions following the user customizable instruction stop the execution of instructions in order to avoid changing the condition of the processor. Consequently, a problem arises with lowered efficiency in instruction execution.

As a method of hazard detection in pipeline processors which include a user customizable instruction unit, stall control utilizing score-boarding is used. The score-boarding device is configured from the device storing the information concerning the instructions in each of the pipelines and stages, and the hazard detection device, itself dependent on the instruction set and pipeline structure. The score-boarding device tends to be very complex, even though the circuit scale is small. There are also methods which use a reorder buffer in pipeline processors not fitted with a user customizable instruction unit.

Nevertheless, in instruction customizable processors, the processor itself and the defined instructions increase in complexity, complicating the score-boarding device. Also, in pipeline processors including a score-boarding device, when a user customizable instruction is added, the pipeline structure executing the added user customizable instruction changes depending upon the user definition. Consequently, for the efficient execution of instructions, it becomes necessary to change the design of the score-boarding device and increase the development period. It is possible to do without the change in the score-boarding device when efficient execution of instructions is unnecessary. However, instruction execution efficiency is adversely affected. In recent years, the speed of pipeline processors with user customizable instruction units has been advancing. It is hoped that, rather than implementing highly complex score-boarding devices, there can be a method established to improve reliability.

Until recently, in regards to methods of improving instruction execution efficiency, pipeline processors without user customizable instruction units utilized reorder buffers.

However, the purpose of using existing reorder buffers is to complete things like instructions issued out-of-order and instructions issued simultaneously in super scalar processors.

### SUMMARY OF THE INVENTION

An aspect of the present invention inheres in a pipeline processor encompassing, an instruction decode unit configured to decode fetched instruction, and to selectively issue one of a user customizable instruction defined by a user and a core instruction, a core instruction execution unit configured to execute the issued core instruction, a user customizable instruction unit configured to execute the issued user customizable instruction, and a reorder buffer configured to temporarily store instruction execution results of the core instruction execution unit and the user customizable instruction unit, and to reorder the instruction execution results in accordance with an order in which the core instruction and the user customizable instruction were issued.

Another aspect of the present invention inheres in a pipeline processor encompassing, an instruction decode unit configured to decode fetched instruction, and to issue an instruction, an instruction execution unit configured to execute the issued instruction, a reorder buffer configured to temporarily store instruction execution results of the instruction execution unit, and to reorder the instruction execution results in accordance with an order in which the instruction was issued, and a timeout controller configured to count clock cycles required for execution of the issued instruction, and to generate a timeout when a count result exceeds a fixed value.

Sill another aspect of the present invention inheres in a method for automatically designing a pipeline processor including an instruction decode unit configured to decode fetched instruction, and to issue an instruction, an instruction execution unit configured to execute the issued instruction, and a reorder buffer configured to temporarily store instruction execution results of the instruction execution unit, and to reorder the instruction execution results in accordance with an order in which the instruction was issued, the method encompassing, acquiring a meta hardware description defining an arrangement and a function of the pipeline processor, acquiring configuration information for adding or a removing hardware description regarding the meta hardware description, and generating a hardware description for the pipeline processor from the meta hardware description in accordance with the configuration information.

### BRIEF DESCRIPTION OF THE DRAWINGS

FIG. 1 is a block diagram showing an arrangement of a pipeline processor according to a first embodiment of the present invention.

FIG. 2 is a table showing a relationship between each stage, each process, each target instruction, and the unit to be used in the pipeline processor according to the first embodiment.

FIG. 3 is a time chart showing the execution of the integer instruction process time in the pipeline processor according to the first embodiment.

FIG. 4 is a time chart showing the operation in executing of load instruction by the pipeline processor according to the first embodiment.

FIG. 5 is a time chart showing an exemplary comparison of the pipeline processor according to the first embodiment.

FIG. 6 is a time chart showing the operation in executing the integer instruction, the user customizable instruction, and the load instruction by the pipeline processor according to the first embodiment.

FIG. 7 is a diagram showing the instruction format of the DSP instruction as the user customizable instruction executed by the user customizable instruction unit according to the first embodiment.

FIG. 8 is a block diagram showing an arrangement of a reorder buffer and a reorder buffer controller according to the first embodiment.

FIG. 9 is a flowchart showing a method for designing a processor according to a modification of the first embodiment.

FIG. 10 is a block diagram showing a processor design apparatus for executing the method according to the modification of the first embodiment.

FIG. 11 is a diagram showing an example of meta hardware description used by the method according to the modification of the first embodiment.

FIG. 12 is a diagram showing configuration information used by the method for designing a processor according to the modification of the first embodiment.

FIG. 13 is a diagram showing the meta hardware description shown in FIG. 11 and the meta hardware description generated by the configuration information shown in FIG. 12.

FIG. 14 is a diagram showing configuration information used by the method for designing a processor according to the modification of the first embodiment.

FIG. 15 is a diagram showing the meta hardware description shown in FIG. 11 and the hardware description generated by the configuration information in FIG. 14.

FIG. 16 is a diagram showing an exemplary meta hardware description used by the reorder buffer design of the first embodiment.

FIG. 17 is a block diagram showing an arrangement of a pipeline processor according to a second embodiment of the present invention.

FIG. 18 is a diagram showing configuration information used by the method for designing a processor according to a modification of the second embodiment.

FIG. 19 shows a diagram of an exemplary meta hardware description used by the method for designing a processor according to the modification of the second embodiment.

FIG. 20 shows a diagram of the hardware description generated by the configuration information shown in FIG. 18 and the meta hardware description shown in FIG. 19.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and description of the same or similar parts and elements will be omitted or simplified. In the following descriptions, numerous specific details are set forth such as specific signal values, etc. to provide a thorough understanding of the present invention. However, it will be obvious to those skilled in the art that the present invention may be practiced without such specific details. In other instances, well-known circuits have been shown in block diagram form in order not to obscure the present invention with unnecessary detail. In the following description, the words “connect” or “connected” defines a state in which first and second elements are electrically connected to each other without regard to whether or not there is a physical connection between the elements.

### FIRST EMBODIMENT

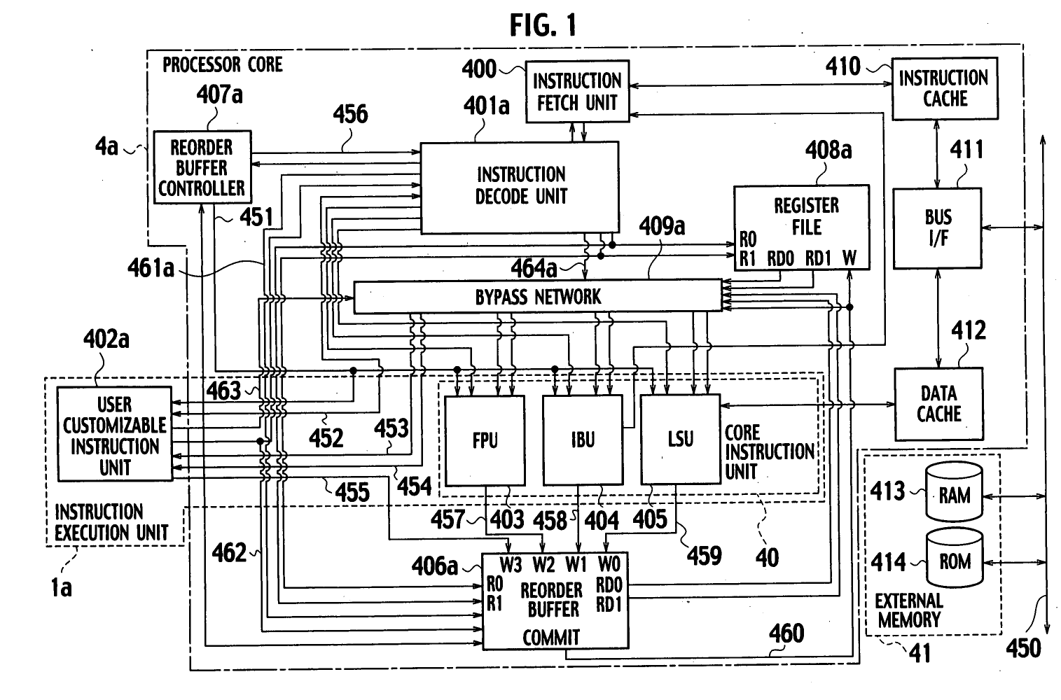

As shown in FIG. 1, a pipeline processor according to a first embodiment of the present invention includes a processor core 4a and a user customizable instruction unit 402a. The processor core 4a is connected to external bus 450. The external bus 450 is connected to an external memory 41.

The processor core 4a includes an instruction fetch unit 400, an instruction decode unit 401a, a core instruction execution unit 40, a register file 408a, a reorder buffer 406a, a reorder buffer controller 407a, an instruction cache 410, a data cache 412, a bus interface (hereinafter abbreviated as “bus I/F”) 411, and a bypass network 409a.

The instruction decode unit 401a decodes the instruction fetched by the instruction fetch unit 400, and selectively issues either a core instruction or a user customizable instruction defined by the user. The core instruction execution unit 40 executes the issued core instruction. The user customizable instruction unit 402a executes the issued user customizable instruction. The reorder buffer 406a temporarily stores the instruction execution results for both the core instruction execution unit 40 and the user customizable instruction unit 402a. The reorder buffer 406a reorders the instruction execution results in accordance with the order in which the core instruction and user customizable instruction were issued. The core instruction execution unit 40 and the user customizable instruction unit 402a configure an instruction execution unit 1a.

The term “core instruction” refers to instructions previously prepared for the processor core 4a. A floating point instruction, an integer instruction, a branch instruction, and a load/store instruction are core instruction, for instance. The number of instruction execution cycles for core instructions is fundamentally a fixed value. A digital signal processor (DSP), a coprocessor, or a combination of these can be utilized as the user customizable instruction unit 402a. The following will explain an example using a DSP as the user customizable instruction unit 402a. In this case, DSP instructions are used as user customizable instructions. The execution cycle of the DSP instructions will change depending on operation data. The number of instruction execution cycles in the DSP instruction is a variable value.

The external memory 41 includes a random access memory (RAM) 413 and a read only memory (ROM) 414. The ROM functions as a program memory storing each instruction executed by the pipeline processor. The RAM functions as a program memory storing each instruction executed in the pipeline processor. The RAM can temporarily store data used during the instruction execution process in the pipeline processor, or it may function as temporary data memory used as work area.

The bus I/F 411 arbitrates both data transmission requests sent from the core instruction execution unit 40 through the data cache 412, and instruction transmission requests sent from the instruction fetch unit 400 through the instruction cache 410. On the results of the arbitration of these two requests, the bus I/F 411 transmits requests to the external bus 450, and transmits and receives data with the external memory 41.

The bus I/F 411 also receives instructions and data read from external memory 41. The bus I/F 411 transmits the data to the data cache 412 and the instructions to the instruction cache 410.

The instruction cache 410 transmits a transmission request to the bus I/F 411 and accepts the instruction transmitted from the bus I/F 411. The data cache 412 transmits a transmission request to the bus I/F 411 and accepts the data transmitted from the bus I/F 411.

The instruction fetch unit 400 transmits a bus request through the instruction cache 410 to the bus I/F 411. The bus request acquires the instruction, which is to be the object of execution by the core instruction unit 40 and the user customizable instruction unit 402a. When the instruction fetch unit 400 receives data from bus I/F 411, the instruction fetch unit 400 transmits the received data to the instruction decode unit 401a as an instruction to be executed.

The instruction decode unit 401a, when the instruction from the instruction fetch unit 400 is a core instruction, decodes the core instruction. The instruction decode unit 401a outputs a control signal that controls the core instruction execution unit 40. When the instruction from the instruction fetch unit 400 is a user customizable instruction (DSP instruction), the decoding of the user customizable instruction (DSP instruction) is handled by a decoder (not illustrated) created within the user customizable instruction unit 402a.

The register file 408a includes multiple registers, and stores the pipeline processor condition and the operation results. The multiple registers of the register file 408a are general-purpose registers used to execute programs. The register file 408a includes first and second readout control ports R0 and R1, first and second readout ports RD0 and RD1 for outputting readout results, and write back-use port W for inputting the results of the execution of instructions that are subject to write back.

A request from the instruction decode unit 401a is input to the first and second readout control ports R0 and R1 of the register file 408a. The request is for a general-purpose register number, required for the execution of instructions.

The following is input to the bypass network 409a: data read from the first and second readout ports RD0 and RD1 of the register file 408a, data read from the first and second readout ports RD0 and RD1 of the reorder buffer 406a, the immediate data of the instruction transmitted via a data line 464a from the instruction decode unit 401a, and the results of the decode of the user customizable instruction transmitted via a data line 463 from the user customizable instruction unit 402a. Consequently, the data necessary to the execution of the instruction is either bypassed or selected, and output to the user customizable instruction unit 402a and the core instruction execution unit 40.

The reorder buffer controller 407a controls the reorder buffer 406a. The reorder buffer 406a includes multiple memory devices for storing the result of instruction execution (each memory device inside the reorder buffer 406a is referred to as “entry” hereinafter). The results of the execution of either user customizable instructions (DSP instructions) or core instructions are written to multiple entries via four write ports (first to fourth write ports W0 to W3). Furthermore, a reorder buffer capable of y simultaneous writing is a reorder buffer with y write ports (y is an integer greater than or equal to 2). Writing the results of instruction execution to the reorder buffer 406a is called “completion”.

Further, the reorder buffer 406a is equipped with two readout control ports (the first and second readout ports R0 and R1) and two readout ports (the first and second readout ports RD0 and RD1).

When an instruction is executed, the instruction decode unit 401a transmits a reorder buffer 406a entry reservation request to reorder buffer controller 407a. Consequently, an empty entry in the reorder buffer 406a is reserved. The reorder buffer controller 407a posts the reserved entry's number as a tag number to the reorder buffer 406a. As a result, after each executed instruction is allocated a tag number, the results of the instruction execution are written to the entry with the corresponding tag number.

The reorder buffer controller 407a outputs the results of instruction execution according to the order in which they were executed. This is carried out by controlling the “first in, first out” (FIFO) of completed instruction execution results. Consequently, The reorder buffer 406a, based on the order that the entries were reserved via requests from the instruction decode unit 401a, outputs instruction execution results to the register file 408a via the data line 460. This operation is called “commit processing.”

When there are no empty entries in the reorder buffer 406a, since instructions cannot be executed, the reorder buffer controller 407a outputs a stall request to the instruction decode unit 401a via the data line 456. The instruction decode unit 401a receives the stall request from the reorder buffer controller 407a and, by stalling D stage of the pipeline, halts the execution of instructions.

When the writing of entry instruction execution results is not yet being handled, the reorder buffer 406a does not carry out commit processing until the writing is completed. Also, the reorder buffer 406a, by emptying those entries which have completed commit processing, assumes a state that can be used by a subsequent entry reservation.

Further, the core instruction execution unit 40 includes the following: a floating point unit (FPU) 403, an integer instruction and branch instruction execution unit (IBU) 404 and a load instruction and store instruction execution unit (LSU) 405.

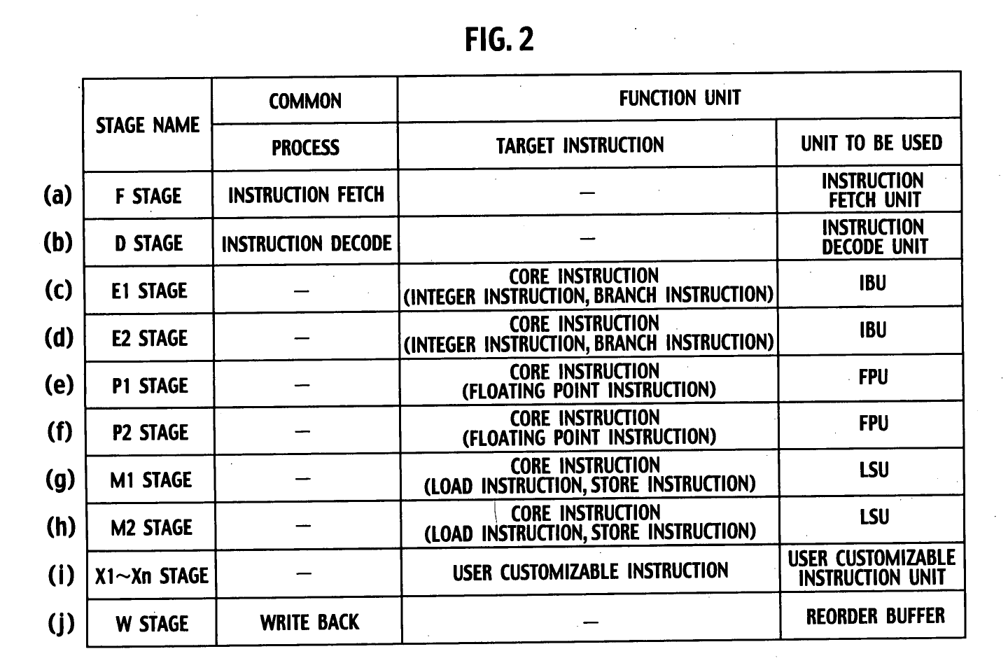

The IBU 404, as shown in FIGS. 2(c) and 2(b), executes integer instructions and branch instructions. The FPU 403, as shown in FIGS. 2(e) and 2(f), executes floating-point instructions. The LSU 405, as shown in FIGS. 2(g) and 2(h), executes load instructions and store instructions.

The core instruction process and the user customizable instruction process have the following three points in common: the F stage shown in FIG. 2(a), the D stage shown in FIG. 2(b) and the W stage shown in FIG. 2(j).

D stage of the core instruction, as shown in FIG. 2(b), is executed by the instruction decode unit 401a. D stage of the user customizable instruction (DSP instruction), primarily, is executed by the user customizable instruction unit 402a.

In detail, the instruction decode unit 401a decodes the core instruction and generates the following information: whether the instruction will be the target of the core instruction's timeout, whether the instruction will necessitate write back to the register file 408a, and whether there is the possibility of generating an exception. This information is transmitted to the reorder buffer 406a via the data line 461a.

In contrast, the user customizable instruction unit 402a decodes the user customizable instruction (DSP instruction) and generates information on whether or not the instruction will necessitate write back to register file 408a and whether there is the possibility of generating an exception. This information is then transmitted to the reorder buffer 406a via the data line 462.

Also, the user customizable instruction unit 402a, the FPU 403, the IBU 404 and the LSU 405 each complete the execution of instructions and write the execution results to the reorder buffer 406a.

Specifically, the instruction execution results for the LSU 405, as shown in FIG. 1, are transmitted to the first write port W0 of the reorder buffer 406a via the data line 459. The instruction execution results for the LSU 405 include: execution results data, signals indicating the validity of execution results data, signals indicating the generation of an exception, and instruction tag numbers.

Also, the instruction execution results for the IBU 404 are transmitted to the second write port W1 of the reorder buffer 406a via the data line 458. The instruction execution results for the IBU 404 include: execution results data, signals indicating the validity of execution results data, signals indicating the generation of an exception, and instruction tag numbers.

Here, an “exception” is generated when, for example, in a division operation, zero is divided. When this occurs, the execution of the division instruction is halted, and the exception process program is executed. After solving the zero division problem, and when the division instruction is restarted in order to recommence the process of the program, it becomes impossible to accurately restart the execution of the program itself. This is because instructions succeeding the division instruction have already been executed, so succeeding instructions are executed twice.

Therefore, when the signal indicates the generation of an exception, the reorder buffer 406a, at the time of completion, discards the entry where the exception-generating instruction execution results are stored. Therefore, commit processing is not performed on execution results stored in the discarded entry.

Also, when the instruction execution results are discarded, all succeeding instruction execution results are discarded as well. All instructions succeeding the instruction generating the exception are discarded. In order to preserve the processor condition, a “precise exception” process can occur.

Further, the reorder buffer 406a, as shown in FIG. 2(j), transmits instruction execution results to the register file 408a in the W stage. In the E Stage, the required clock cycle, although fixed at two cycles, for example, in the core instruction, is n cycles in the user customizable instruction (DSP) (n; an integer greater than or equal to 2). Furthermore, the number of execution stages changes from X1 to Xn stages, depending on the type of user customizable instruction (DSP).

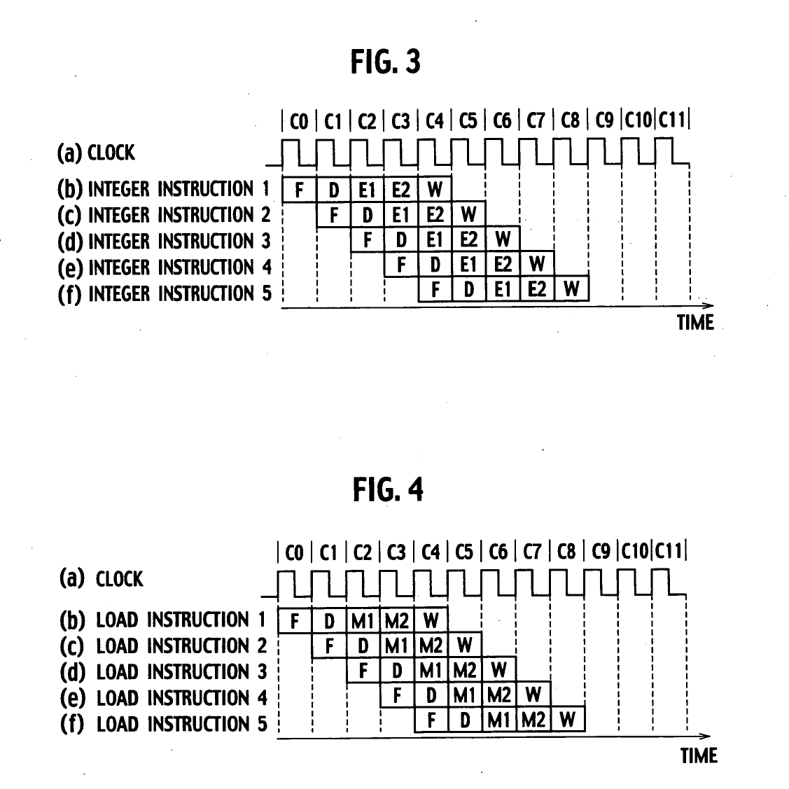

The following, referencing the time chart in FIG. 3, explains the outline of the operations at the time of the integer instruction process in the pipeline processor shown in FIG. 1. The time chart in FIG. 3, when each integer instruction in FIGS. 3(b) to 3(f) is executed, shows the timing of each stage in each cycle Ck of the clock shown in FIG. 3 (k; an integer greater than 0). This is provided that no hazard is generated during the execution of each integer instruction. To continue, each integer instruction is processed in F stage, D stage, first integer instruction execution stage (hereinafter referred to as “E1 stage”), second integer instruction execution stage (hereinafter referred to as “E2 Stage”), and W stage.

In cycle 0 of FIG. 3(b), F stage is executed for an integer instruction 1. In F stage, the instruction fetch unit 400 shown in FIG. 1 fetches the integer instruction 1 from the instruction cache 410, which is then transmitted to the instruction decode unit 401a.

In cycle C1 of FIG. 3(b), D stage is executed for the integer instruction 1. Simultaneously, F stage is executed for an integer instruction 2 shown in FIG. 3(c). In D stage, the instruction decode unit 401a, the fetched integer instruction 1 is interpreted, the control signal to control the IBU 404 is generated, and data is read from the general purpose registers within the register file 408a, if necessary. The control signal generated by the instruction decode unit 401a and the data read from the register file 408a are transmitted to the IBU 404. Moreover, the instruction decode unit 401a, as shown in cycles C1 to C5 in FIG. 3, issues one instruction to one cycle.

In cycle C2 of FIG. 3(b), E1 stage is executed for the integer instruction 1. Moreover, D stage is executed for the integer instruction 2 and F stage is executed for an integer instruction 3.

In cycle C3 of FIG. 3(b), E2 stage is executed for the integer instruction 1. Simultaneously, E1 stage is executed for the integer instruction 2, D stage is executed for the integer instruction 3 and F stage is executed for an integer instruction 4. The execution result obtained from the execution of E2 stage for the integer instruction 1 is momentarily reserved in the reorder buffer 406a.

In cycle 4 of FIG. 3(b), W stage is executed for the integer instruction 1. Furthermore, E2 stage is executed for the integer instruction 2, E1 stage is executed for the integer instruction 3, D stage is executed for the integer instruction 4, and F stage is executed for an integer instruction 5. In W stage executed for the integer instruction 1, the reorder buffer 406a writes the execution results of the integer instruction 1 to the register file 408a.

In this way, by have each of F stage, D stage, E1 stage, E2 stage, and W stage acting independently, before each stage completes one integer instruction, the next integer instruction process is commenced in parallel. Consequently, the pipeline processor in FIG. 1, granted there are no hazards, is capable of executing integer instructions by throughput of one instruction in one cycle. Moreover, the floating point instruction process and the integer instruction process both act in the same manner.

The following, referring to the time chart in FIG. 4, explains the outline of the operations at the time of the load instruction process in the pipeline processor shown in FIG. 1. However, descriptions identical to those of the aforementioned integer instruction process will be abbreviated. Each load instruction is processed by F stage, D stage, a first load instruction execution stage (hereinafter referred to as “M1 Stage”), a second load instruction execution stage (hereinafter referred to as “M2 Stage”), and W stage.

In cycle C0 of FIG. 4(b), F stage is executed for load instruction 1.

In cycle C1 of FIG. 4(b), D stage is executed for a load instruction 1. In D stage, the instruction decode unit 401a interprets the fetched load instruction 1 and generates a control signal to control the LSU 405. The control signal generated by the instruction decode unit 401a is supplied to the LSU 405.

In cycles C2 and C3 of FIG. 4(b), M1 stage and M2 stage are executed for Load Instruction 1. In M1 stage and M2 stage, LSU 450, depending on the control signal, receives data read from the external memory 41.

In cycle C4 of FIG. 4(b), W stage is executed for Load Instruction 1. In W stage, the reorder buffer 406a writes data obtained from E1 and E2 stages to the register file 408a.

Load instructions 2 to 5, shown in FIG. 4(c) to 4(f), are processed in the same manner as Load Instruction 1. In this way, by have each of F stage, D stage, E1 stage, E2 stage, and W stage acting independently, before each stage completes one load instruction, the next load instruction process is commenced in parallel.

In accordance with the above, the pipeline processor shown in FIG. 1 handles the readout of data necessary to the operation from the register file 408a in D stage. It also handles the writing of instruction information to the register file 408a in W stage. The following, as an exemplary comparison, describes a sample operation when there is no the reorder buffer 406a as shown in FIG. 1.

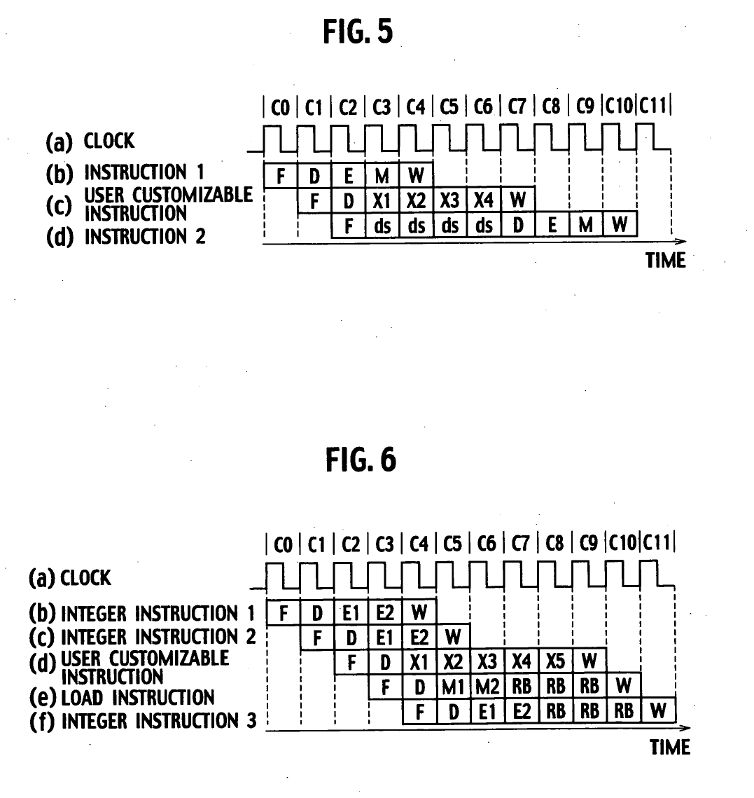

As shown in FIGS. 5(b) and 5(d) (Core) instruction 1 and 2, processed by each of F stage, D stage, E stage, M stage, and W stage, are defined. Further, as shown in FIG. 5 (c), user customizable instructions (DSP instructions), processed by each of F stage, D stage, E stage, M stage, and W stage, are defined.

Because there are four cycles in the execution cycle of the user customizable instruction (DSP instruction) shown in FIG. 5(c), the sequence in which instructions are issued and the sequence instructions are executed are swapped. This state of swapped sequences is called “out of order”. WAW hazards are generated by out of order. Therefore, because the number of execution cycles of the user customizable instruction (DSP instruction) shown in FIG. 5(c) is variable, a WAW hazard is generated between it and the instruction 2 shown in FIG. 5(d).

When the reorder buffer 406a shown in FIG. 1 is not included, pipeline stall is performed in order to solve the WAW hazard, as in FIG. 5(d). Moreover, the signal “ds” shown in FIG. 5(d) indicates a condition of D stage in stall.

On the other hand, when the reorder buffer 406a shown in FIG. 1 is included, the execution results that have become “out of order” can be rearranged into “in order”. Furthermore, when using the reorder buffer 406a, even when executing a number of instructions that differs from the number of execution cycles, it is possible to solve WAW hazard.

The following, referring to the time chart in FIG. 6, explains the outline of the operations at the time of the integer instruction process, the load instruction process, and the user customizable instruction process in the pipeline processor shown in FIG. 1. However, descriptions identical to those of the aforementioned integer instruction process and load instruction process will be abbreviated. Also, it is assumed that no hazards beyond WAW hazards have been generated. As in the time chart shown in FIG. 6, Signal “RB” indicates that instruction execution results have been stored in the reorder buffer 406a.

The user customizable instruction (DSP instruction) shown in FIG. 6 (c) is processed in the execution stages of X1 stage through X5 stage. Before the execution stage of the user customizable instruction (DSP instruction) completes in cycle C8, the execution stage of the load instruction shown in FIG. 6(e) completes in cycle C7.

Both the user customizable instruction (DSP instruction) shown in FIG. 6 (c) and the execution results of the load instruction shown in FIG. 6(e) are stored in the reorder buffer 406a. The reorder buffer controller 407a, until W stage is completed for the user customizable instruction (DSP instruction) shown in FIG. 6(c), reserves the execution results of the load instruction shown in FIG. 6(e) are in The reorder buffer 406a. Consequently, W stage for the load instruction shown in FIG. 6(e) is executed in cycle C10. In this way, as in FIG. 6, there is no stall in the load instruction shown in FIG. 6(e) when compared to FIG. 5. Furthermore, it is possible to execute succeeding instructions without stall, and without referencing the execution results of user customizable instructions (DSP instructions).

Again, the load instruction shown in FIG. 6 (e), in cycle C7 is reserved in the reorder buffer 406a. In cycle C7, the execution stage of integer instruction 3, shown in FIG. 6 (f), is complete. The execution results of integer instruction 3 are written to the reorder buffer 406a. The reorder buffer controller 407a, until the completion of W stage of the load instruction shown in FIG. 6(e), reserves the execution results of Integer Instruction 3 in the reorder buffer 406a. Consequently, W stage for integer instruction 3 is executed in cycle C11.

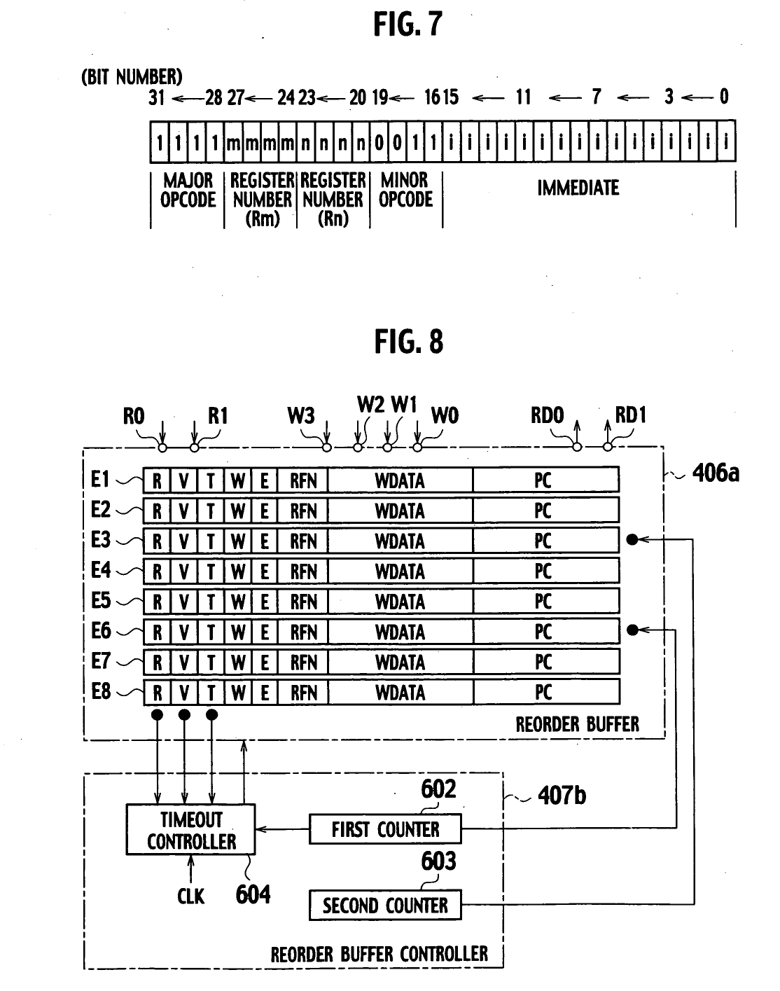

The following, using FIG. 7, describes an exemplary instruction format for the user customizable instruction (DSP instruction). In the example shown in FIG. 7, five bit fields are defined. The user customizable instruction (DSP instruction) has the following: 4-bit major op-code, 4-bit register number Rm, 4-bit register number Rn, 4-bit minor op-code, and 32 bits of the immediate value of 16 bits.

Bit numbers 0 to 15 are immediately allocated. When the user has defined an optional user customizable instruction (DSP instruction), it is used immediately. For example, by using the discrimination of the user customizable instruction (DSP instruction) into the highest four bits (bit numbers 12 to 15), it is possible to define 16 user customizable instructions (DSP instructions).

Bit numbers 16 to 19 are allocated into the minor op-code. The minor op-code of the user customizable instruction (DSP instruction) is “0011”. Both register number Rm and register number Rn are the numbers for the registers used in the operation. They each indicate a single general purpose register within the register file 408a shown in FIG. 1.

Bit numbers 20 to 23 and bit numbers 24 to 27 are allocated to register number Rn and register number Rm, respectively. Bit numbers 28 to 31 are allocated to the major op-code. The major op-code of the user customizable instruction (DSP instruction) is “1111”.

Further, the data line 452, which connects the instruction decode unit 401a and the user customizable instruction unit 402a (as shown in FIG. 1), transmits things such as the “medpDCode” signal, which indicates the immediacy of the user customizable instruction, as shown in table 1.

TABLE 1

| Data line | Data (signal) name | Bit width | Direction (I/O) |
|---|---|---|---|
| Data line 451 | medpDRobIndex | [2:0] | O |
| Data line 452 | medpDCode | [23:0] | O |
| | medpDValid | 1 | O |
| | dpmeDBusy | 1 | I |
| Data line 453 | medpERmData | [31:0] | O |
| Data line 454 | medpERnData | [31:0] | O |
| Data line 463 | dpmeDOpUse | [1:0] | O |
| Data line 462 | dpmeDReExPossibility | [1:0] | O |
| Data line 455 | dpmePAck | 1 | I |
| | dpmePRobIndex | [2:0] | I |
| | dpmePResultData | [31:0] | I |
| | dpmePValid | 1 | I |
| | dpmePExcept | 1 | I |

In table 1, the signal “medpDRobIndex” refers to entry number for the reorder buffer for the user customizable instruction. The signal “medpDCode” refers to value of the immediate and operand (Rm, Rn) use bit field. The signal “medpDValid” refers to a signal indicating the value of “medpDCode” is valid. The signal “dpmeDBusy” refers to a signal indicating the user customizable instruction unit cannot accept an instruction. The signal “medpERmData” refers to value of operand Rm. The signal “medpERnData” refers to value of operand Rn. The signal “dpmeDOpUse” refers to a signal indicating whether operand is in use. The signal “dpmeDReExPossibility” refers to a signal indicating whether write back is necessary. The signal “dpmePAck” refers to a signal reporting completion of user customizable instruction to the processor core. The signal “dpmePRobIndex” refers to entry number for the reorder buffer of the completed instruction. The signal “dpmePResultData” refers to value of the user customizable instruction execution results. The signal “dpmePValid” refers to a signal indicating whether value of dpmePResultData is valid. The signal “dpmePExcept” refers to a signal indicating generation of an exception in the user customizable instruction.

Moreover, the code [A:B] for bit width shown in Table 1 indicates a bit width from bit B to bit A. For example, the bit width [2:0] for the signal “medpDRobIndex” indicates three bits width from bit 0 to bit 2. The “Direction [I/O],” shown in Table 1 indicates the following: when the symbol is “I” data (signal) has been transmitted from the user customizable instruction execution unit 402a to the processor core 4a, and when the symbol is “O,” data (signal) has been transmitted from the processor core 4a to the user customizable instruction unit 402a.

For example, when the user defines sixteen instructions using the highest four bits shown in FIG. 7, the allocation of user customizable instructions is performed by decoding the highest four bits in User customizable instruction unit (DSP) 402a.

The user customizable instruction unit 402a, depending on the allocation results of the user customizable instruction, generates the “dpmeDOpUse” signal shown in table 1. The “dpmeDOpUse” signal is a 2-bit signal showing whether the user customizable instruction is using register numbers Rm and Rn. When either register number Rm or Rn is being used, the corresponding bit becomes 1. When neither is being used, the corresponding bit becomes 0. For example, when the signal “dpmeDOpUse” is “11” in binary code, it indicates the instruction is using both register numbers Rm and Rn. When the signal “dpmeDOpUse” is “00” in binary code, it indicates that neither register number Rm nor Rn is being used.

The instruction execution results for the user customizable instruction unit 402a are transmitted to the fourth write port W3 of the reorder buffer 406a via the data line 455. Included in these instruction execution results are, as shown in table 1, the following: the execution results data “dpmePResultData”, the signal indicating the validity of the data “dpmePValid,” the signal indicating the generation of an exception “dpmePExcept”, and the instruction tag number “dpmePRobIndex”.

Further, the reorder buffer 406a, as shown in FIG. 8, includes, for example, 8 entries (first to eighth entries E1 to E8). However, the number of entries is not limited to 8. It is permissible to change the entry count to a number suitable to the number of pipeline levels.

Each entry includes the following: a 1-bit R flag, a 1-bit C flag, a 1-bit T flag, a 1-bit W flag, a 1-bit E flag, a 5-bit RFN field, a 32-bit WDATA field, and a 32-bit PC field.

As an example, the “R flag” of the first entry E1 indicates whether the first entry E1 currently in use. Therefore, when the logic value of R flag is “1”, first entry E1 is currently in use, and when the logic value is “0,” first entry E1 is not currently in use.

Further, the “V flag” of the first entry E1 indicates whether instruction execution results allocated to the first entry E1 have been written. When the logic value of the V flag is “1,” it indicates that the instruction execution results allocated to the first entry E1 have been written. When the logic value is “0,” it indicates that they have not been written.

The “T flag” of the first entry E1 indicates if the instructions allocated to the first entry E1 have been targeted for a timeout. When the logic value of the T flag is “1,” it indicates that the instructions have been targeted for a timeout. When the logic value is “0,” it indicates that they have not been targeted for a timeout.

The “W flag” of the first entry E1 indicates whether it is necessary to write back the instructions allocated to the first entry E1 to the register file 408a. When the logic value of the W flag is “1”, it indicates that a write back of the instructions is necessary. When the logic value is “0,” it indicates that a write back is not necessary.

The “E flag” of the first entry E1 indicates whether the instructions allocated to first entry E1 are capable of generating an exception. When the logic value of the E flag is “1,” it indicates that the instructions are capable of generating an exception. When the logic value is “0,” it indicates that they are not capable of generating an exception.

The “RFN field” of the first entry E1 indicates the register number for the updated register file 408a, depending on the instructions allocated to the first entry E1. The “WDATA field” of the first entry E1 is a field where the execution results of the instructions allocated to the first entry E1 are stored. The “PC field” of the first entry E1 is a field where the program counter for the instructions allocated to the first entry E1 is stored. Second to Eighth entries E2 to E8 are all compiled in a manner identical to that of the first entry E1.

Further, the reorder buffer controller 407a primarily includes a first counter 602, used in commit processing, and a second counter 603, which generates tag numbers. As an example, both the first counter 602 and the second counter 603 have a bit length of 3 bits. Therefore, they are capable of expressing 8 pattern values. As such, in decimal code, a value of “7” and a value or “1” when added, would become “0”.

The instruction decode unit 401a executes an instruction and, in the succeeding cycle, increases the value of the second counter 603 by 1. The value of the second counter 603 is used as a tag number, which is transmitted to the reorder buffer 406a via the data line 451, both shown in FIG. 1. By the counter value of the first counter 602, one entry is assigned, chosen from among the first to eighth entries E1 to E8. In the same way, by the counter value of the second counter 603, one entry is assigned, chosen from among the first to eighth entries E1 to E8.

Depending on the instruction decode unit 401a, an instruction is issued and the logic value of the R flag for the entry assigned by the second counter 603 is set to “1”. Also, the register number of the register file 408a, updated by the issued instruction, is set to the RFN field of the entry assigned by the second counter 603.

Further, when the issued instruction necessitates write back, the logic value of the W flag for the entry assigned by the second counter 603 is set to “1”. In contrast, when the issued instruction does not necessitate write back, the logic value of the W flag is set to “0”.

When the issued instruction is capable of generating an exception, the logic value of the E flag for the entry assigned by the second counter 603 is set to “1”. When the issued instruction is not capable of generating an exception, the logic value of the E flag is set to “0”.

As an example, when the issued instruction is a user customizable instruction (DSP instruction), the logic value of the T flag for the entry assigned by the second counter 603 is set to “1”. When the issued instruction is a core instruction, the value set for the T flag differs, depending on the type of core instruction.

The reorder buffer 406a generates completion unaccompanied by the generation of an exception and writes execution results to the WDATA field of the entry assigned by the second counter 603. Also, the logic value of the V flag is set to “1”.

The reorder buffer 406a, when the entry assigned by the first counter 602 has an R flag logic value of “1” and a V flag logic value of “1,” outputs a request to the register file 408a. This request is for the writing of WDATA field data to the register number indicated by the RFN field. This process is the aforementioned “commit processing”.

The reorder buffer 406a, in the cycle succeeding commit processing, sets the entry's R flag, V flag, and T flag logic value to “0”. When an exception has been generated, in descending order from the value of the first counter 602, the entry ending in the counter value of the second counter 603 is scanned, and the logic value of that R flag is set to “0”. Then, the value of the second counter 603 is set to that of the first counter 602. Consequently, the execution results for instructions succeeding the instruction that generated an exception are discarded. It is then possible to perform the precise exception process.

Following is an explanation of the timeout controller 604 shown in FIG. 8. In the user customizable instructions (DSP instructions), function definition and implementation are left up to the user. Even when executing a user customizable instruction (DSP instruction), when execution results are not transmitted to the processor core 4a, and when succeeding instructions reference the execution results, the processor stops until execution results are transmitted. This condition is called “hang-up”.

Systems which produce hang-up caused by a bug in the hardware or programming are unreliable. The system's overall security becomes especially difficult as the processor reliability becomes dependent upon the function definition of a user customizable instruction and upon the user customizable instruction unit 402a which executes that user customizable instruction.

Further, in the stages of hardware and program development, if hang-up is produced due to a bug, the time necessary to debug is increased. This is because, outside of a reset, there is no way to restart the processor's instruction execution. Further, because a debugger cannot be used to investigate the conditions at the time of hang-up, it takes time for bug analysis.

The timeout controller 604 shown in FIG. 8, when instruction execution is halted for a fixed time, restarts the processor's instruction execution by discarding instruction execution results. That is, the timeout controller 604 counts the number of instruction execution cycles and generates the timeout when the instructions don't complete within the established number of cycles. An exception process or an interrupt process, for example, can be used as a timeout. The following is an example usage of an interrupt as a timeout process.

A user customizable instruction executed by the user customizable instruction unit 402a cannot complete its execution if a completion request is not sent from the user customizable instruction unit 402a. Consequently, if a completion request is not sent, the moment the entry for the reorder buffer 406a becomes full, instruction execution becomes impossible. This indicates the halt of the processor.

The timeout controller 604 monitors the entry assigned by the first counter 602, and when completion cannot be generated within the fixed cycle period, causes an exception to be generated. The following is an explanation of the process that causes the generation of an exception.

The timeout controller 604 commences the count of the number of clock cycles when the logic value of the T flag and the R flag for the entry assigned by the count value of The first counter 602 is set to “1”, and the logic value of the V flag for the same is set to “0”. If the logic value of the V flag becomes “1”, the count is halted.

As an example, if the count of the number of clock cycles exceeds 4096, the timeout controller 604 processes the instruction of the entry assigned by the first counter 602 as if it had generated an exception.

Moreover, the number of clock cycles that becomes a criterion for the generation of a timeout process is not limited to the previous example of 4096 cycles. For example, 8192 clock cycles, 16384 cycles, etc. can become a criterion. The editing of the number of clock cycles is possible when using the meta hardware described below. By using the value set in the special register of the register file 408a as the number of clock cycles that become the criterion for generating a timeout process, it is also possible to use the value established in the program by the user.

As described above, according to the first embodiment of the present invention, by using, not the score-boarding method, but the reorder buffer 406a, it is possible to offer a pipeline processor capable of: efficient execution of instruction groups which include user customizable instructions (DSP instructions) with an optional execute cycle; and capable of user customizable instructions with a high degree of freedom in regards to the number of execution cycles and exception generation. Consequently, because the complexity of the pipeline processor has been lessened, high speed operations are possible, and a highly reliable pipeline processor can be configured. Further, because the timeout controller 604 can generate a timeout process, it is possible to further enhance the reliability of the pipeline processor.

### Modification of First Embodiment

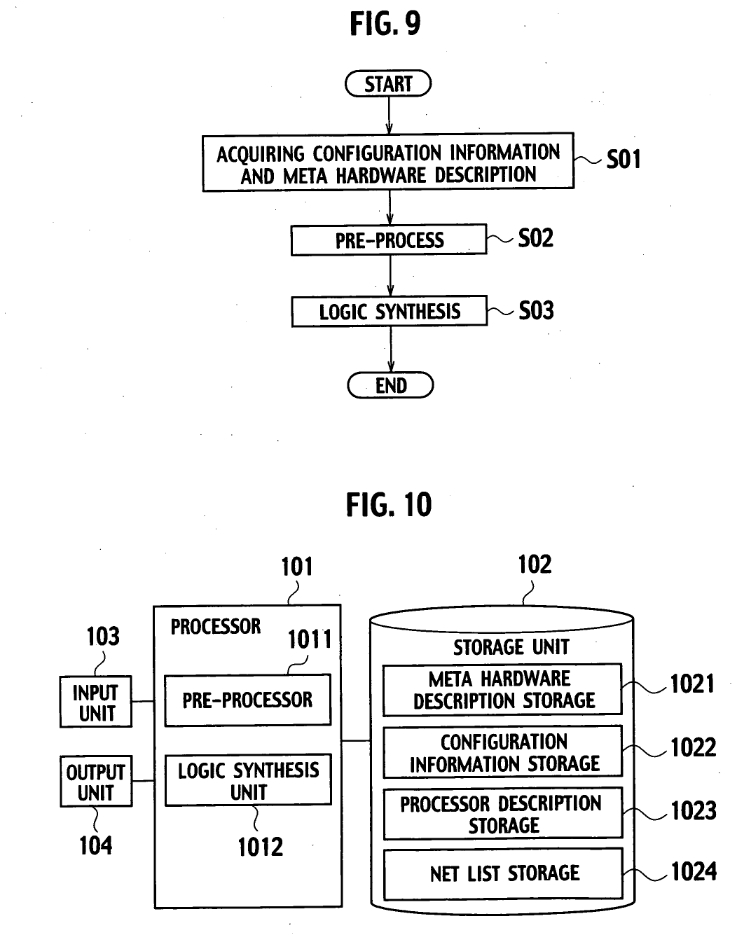

As shown in FIG. 9, following is a description of the design of the pipeline processor shown in FIG. 1, as a modification of the first embodiment of the present invention. A processor design apparatus shown in FIG. 10 implements each process shown in FIG. 9. The processor design device shown in FIG. 10 includes a processor 101, a memory unit 102, an input Unit 103, and an output unit 104.

Stored in the memory unit 102 is the following: the “configuration information”, which is the hardware description that described such things as the conditions of configuration and function in the process being designed; and the “meta hardware description,” which adds or removes hardware description according to the configuration information.

Based on the configuration information and the meta hardware description, the hardware description of the processor being designed is configured. In this way, the processor being designed is called a “configurable processor”. The configurable processor, according to the configuration information, is designed depending on the processor design device, which automatically adds or removes hardware description.

By using the meta hardware description it is possible to add or remove hardware description according to the user's demands. However, doing so increases the cost of function verification. For example, there are eight parameters as configuration information. When each of those parameters takes a value of “1” or “0,” it is possible to design a circuit that has a difference of factor 2 of 8, that is, a 256 pattern. Recently, even assuming function verification was made automatic, 256 times the calculation time is necessary.

When reducing calculation time, depending on the limits of dependant relationships between parameters and the reduction of the number of parameters, the elimination of verification space becomes necessary. To the degree that hardware configuration and operation is concise, it is possible to eliminate verification space. In the score-boarding device described previously, because hardware configuration and operation is complex, in order to eliminate the time necessary to verify function, it is common for limits to be placed on things like the function of the score-boarding device.

In contrast, with the pipeline processor shown in FIG. 1, because it makes use of the reorder buffer 406a with more concise hardware configuration and operation than a score-boarding device, it is possible to satisfactorily guarantee the time necessary for function verification.

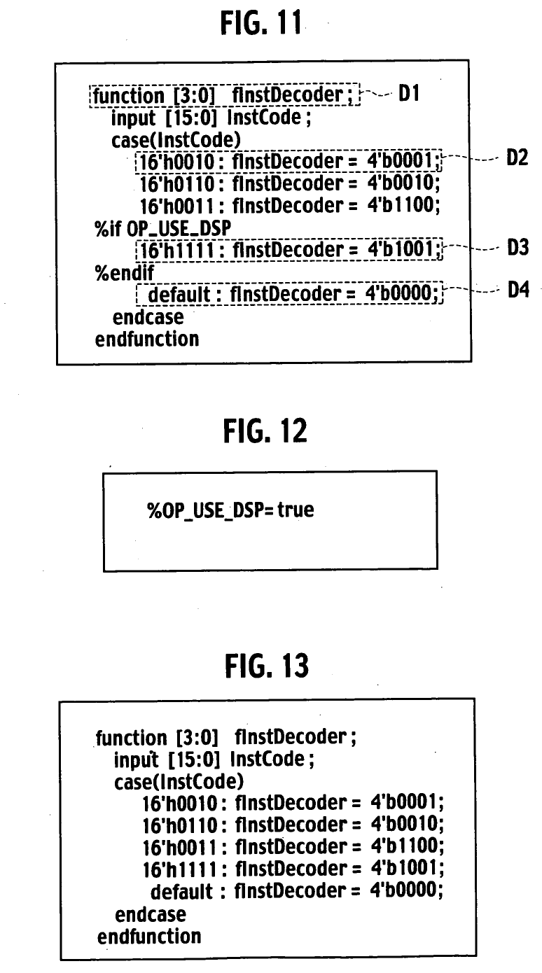

The meta hardware description, as shown in FIG. 11, has other languages, for example, as based on things like Verilog-HDL, embedded in the hardware description language (HDL). These other embedded languages are called “meta control languages”. Meta control language begins with the beginning of line (BOL) symbol “%”. In the example shown in FIG. 11, the descriptions “%if OP_USE_DSP” and “%endif” correspond to meta control language. The configuration information, as shown in FIG. 12, is described by meta control language.

The processor 101 shown in FIG. 10 executes each function of both a pre-processor 1011 and a logic synthesis unit 1012. The pre-processor 1011 reads meta hardware description and configuration information from the storage unit 102, executes meta control language, and implements hardware description for the processor being designed. The logic synthesis unit 1012 logic synthesizes the hardware description for the processor being designed, and implements the net list for the processor being designed.

Following is a description of the processor design method relating to the Modification of the First Embodiment of the Present Invention, referencing the flowchart shown in FIG. 9. As an example, this will describe the procedure, when the user customizable instruction (DSP instruction) is not used from the meta hardware description and configuration information, of automatically adding or removing one decode function to the user customizable instruction (DSP instruction) of the instruction decode unit 401a shown in FIG. 1. In this instance, the type of meta hardware description shown in FIG. 11 is prepared.

Furthermore, the Description D1 shown in FIG. 11 is an HDL definition function. Description D2 indicates that when the hexadecimal code “0010” is input, it is decoded to binary code“0001”. The two rows connected to description D2 are the same description as description D2. Description D3 is description added or removed by the configuration information.

Description D4 is the description called the default item. The default item is chosen when, in the case statement, there is not a single input signal enumerated other than the default item. For example, in FIG. 11, when the input was “4321”, the default item is chosen, and “0000” is obtained as the decode results.

When the “%if OP_USE_DSP” parameter for the configuration information is set to “true”, it indicates the use of the user customizable instruction (DSP instruction). When the “%if OP_USE_DSP” parameter for the configuration information is set to “false”, it indicates the user customizable instruction (DSP instruction) is not used.

In Step S01, the Pre-processor 1011 shown in FIG. 10 obtains the following: the meta hardware description stored in a meta hardware description storage 1021, and the configuration information stored in the configuration information storage.

In Step S02, the logic synthesis unit 1011 executes meta control language and implements hardware description for the processor being designed. Specifically, when the “%if OP_USE_DSP” parameter for the configuration information obtained in Step S01 is “true”, as shown in FIG. 12, it implements hardware description that included description D3. This hardware description is the if statement condition section from “%if OP_USE_DSP” to “%endif” from within the meta hardware description shown in FIG. 11. Consequently, the hardware description shown in FIG. 13 is implemented, and stored to a processor description storage 1023.

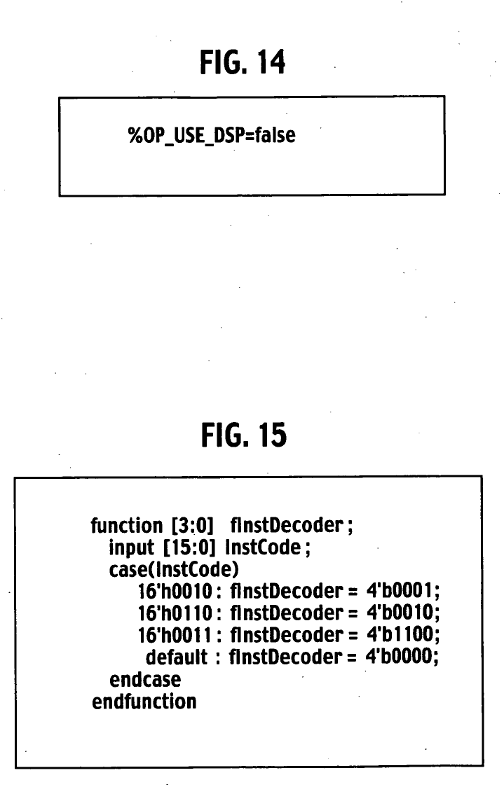

Conversely, when the “%if OP_USE_DSP” parameter for the configuration information obtained in Step S01 is “false,” as shown in FIG. 14, it implements hardware description that removed Description D3. This hardware description is the if statement condition section from “%if OP_USE_DSP” to “%endif” from within the meta hardware description shown in FIG. 11. Consequently, the hardware description shown in FIG. 15 is implemented and stored in Processor Description Storage 1023.

In Step S03, the logic synthesis unit 1012 shown in FIG. 10 logic synthesizes the hardware description stored in the processor description storage 1023, and implements the net list for the processor being designed. The implemented net list is stored in net list storage 1024.

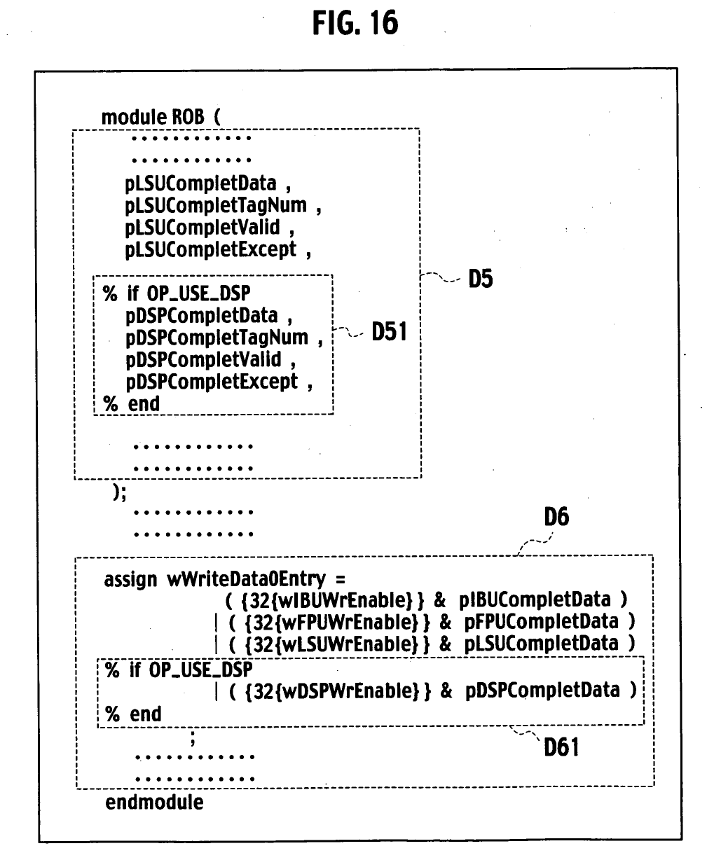

Further, if the meta hardware description shown in FIG. 16 is used in exchange for that one shown in FIG. 11, when the user customizable instruction unit 402a shown in FIG. 1 is not used, it is possible to automatically add or remove the write port W3 for the reorder buffer 406a.

Description D5, shown in FIG. 16, enumerates input-output signals for the reorder buffer 406a. Description D51 from within Description D5 is hardware description corresponding to port W3 for the reorder buffer 406a.

Description D6, shown in FIG. 16, is defined as the selector which chooses execution results for one of the following: the user customizable instruction unit 402a, the FPU 403, the IBU 404, and the LSU 405, all shown in FIG. 1. Description D61 from within description D6 is hardware description corresponding to the execution results of the user customizable instruction unit 402a.

As described above, in the method of designing the processor in the modification of the embodiment of the present invention, by automatically implementing hardware description according to configuration information, it is possible to easily obtain the most appropriate hardware description. Consequently, instead of using the score-boarding method, user customizable instructions with a high level of freedom in regards to number of execution cycles and exception generation are possible. It is also possible to design pipeline processors with efficiently executable instruction groups which include user customizable instructions (DSP instructions) with optional execution cycles.

### SECOND EMBODIMENT

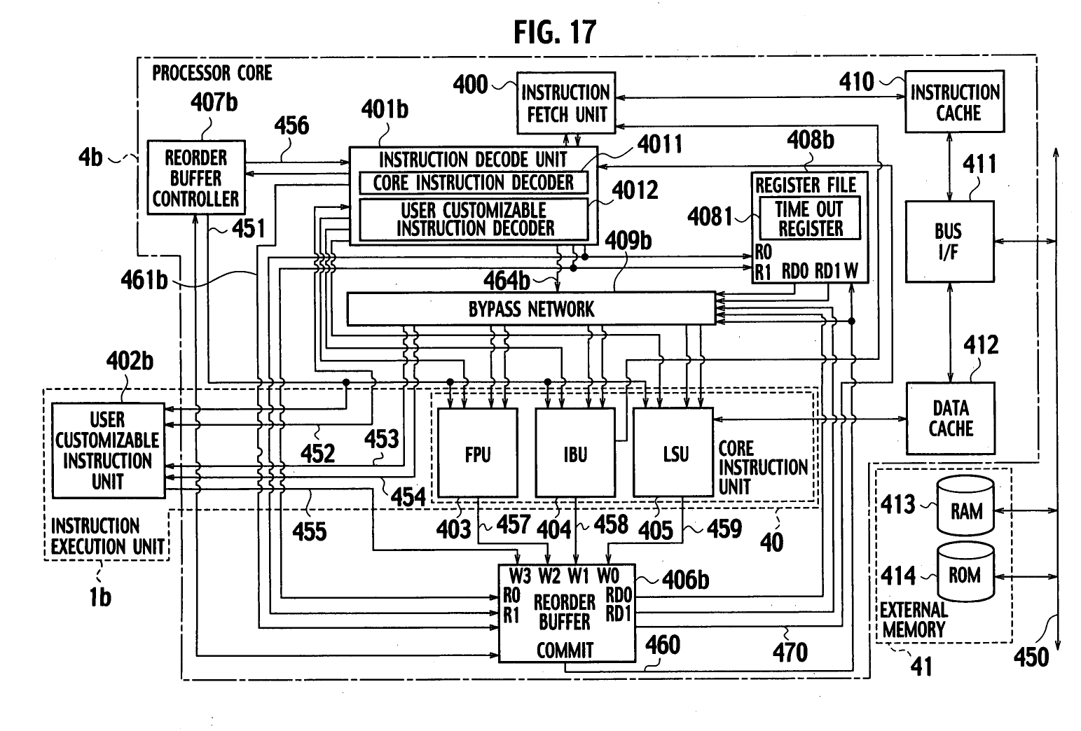

The pipeline processor in the second embodiment of the present invention, as shown in FIG. 17, differs from that in FIG. 1, where the instruction decode unit 401b executes each function of both a core instruction decoder 4011 (which decodes core instructions) and a user customizable instruction decoder 4011 (which decodes one part of the user customizable instruction). That is, the instruction decode unit 401b adds one part of the decode function of the user customizable instructions necessary to the control of both the reorder buffer 406a and the bypass network 409a, to the User Decode Unit 401a shown in FIG. 1.

Basically, the instruction decoder can easily become the critical pass which decides the maximum clock frequency of the processor. When the user customizable instruction unit 402a, shown in FIG. 1, configures the decoding of user customizable instructions (DSP instructions), the maximum clock speed deteriorates due to line delay.

In FIG. 1, the user customizable instruction unit 402a performed decoding of the user customizable instruction (DSP). As a result, the data line 463 was created to transmit the “dpmeDOpUse” signal. This signal indicates whether or not the user customizable instruction operand is used between the user customizable instruction unit 402a and the processor core 4a.

Also, in FIG. 1, the data line 462 was created to transmit the “dpmeDReExPossibility” signal which indicates whether or not a return value exists in the user customizable instruction (DSP instruction) between the user customizable instruction unit 402a and the processor core 4a. Furthermore, this signal indicates whether or not write back is necessary.

As shown in FIG. 1 and table 1, the user customizable instruction unit 402a can generate a “dpmeDOpUse” signal and a “dpmeDReExPossibility” signal within one cycle. When this happens, the possibility increases for the user customizable instruction unit 402a, the instruction decode unit 401a, and the reorder buffer 406a on the chip to be set up in an alienated layout, and thus the data line 462 and the data line 463 become critical bus.

Conversely, in FIG. 17, the instruction decode unit 401b decodes one part of the user customizable instruction (DSP instruction) and generates a “dpmeDOpUse” signal and a “dpmeDReExPossibility” signal. Consequently, as shown in FIG. 17 and table 2, the data line 463 and 462, shown in FIG. 1 and table 1, are unnecessary.

TABLE 2

| Data line | Data (Signal) Name | Bit width | Direction (I/O) |
|---|---|---|---|
| Data line 451 | medpDRobIndex | [2:0] | O |
| Data line 452 | medpDCode | [23:0] | O |
| | medpDValid | 1 | O |
| | dpmeDBusy | 1 | I |
| Data line 453 | medpERmData | [31:0] | O |
| Data line 454 | medpERnData | [31:0] | O |
| Data line 455 | dpmePAck | 1 | I |
| | dpmePRobIndex | [2:0] | I |
| | dpmePResultData | [31:0] | I |
| | dpmePValid | 1 | I |
| | dpmePExcept | 1 | I |

In table 2, the signal “medpDRobIndex” refers to number of the user customizable entry. The signal “medpDCode” refers to value of the immediate value and operand-use (Rm, Rn) bit field. The signal “medpDValid” refers to a signal indicating that the value of medpDCode is valid. The signal “dpmeDBusy” refers to a signal indicating that user customizable instruction unit cannot accept an instruction. The signal “medpERmData” refers to value of Operand Rm. The signal “medpERnData” refers to value of Operand Rn. The signal “dpmePAck” refers to a signal notifying the processor core of user customizable instruction completion. The signal “dpmePRobIndex” refers to number of the completed instruction's reorder buffer entry. The signal “dpmePResultData” refers to value of user customizable instruction execution results. The signal “dpmePValid” refers to a signal indicating value of dpmePResultData is valid. The signal “dpmePExcept” refers to a signal indicating the generation of an exception by the user customizable instruction.

The “dpmeDOpUse” signal generated by the instruction decode unit 401b is transmitted to the bypass network 409b via data line 464b, shown in FIG. 17. The “dpmeDReExPossibility” signal generated by the instruction decode unit 401b is transmitted to the reorder buffer 406a via data line 461b, shown in FIG. 17.

Also, the first embodiment uses the method of generating exceptions as a timeout process. However, the second embodiment uses interrupt as a timeout process. The register file 408, shown in FIG. 17, includes a timeout register 4081, which indicates the generation of a timeout process.

In the same manner as the first embodiment, the timeout controller 604 and the reorder buffer 406b, both shown in FIG. 8, after detecting a timeout, set all entry R flags to 0, and write a logic value of “1” to the timeout register 4081. Further, an interrupt request is performed for the instruction decode unit 401b via data line 470.

Following is a description of the procedure for the interrupt process for the reorder buffer 406b. The reorder buffer 406b generates a timeout, the instruction's entry V flag is set to a logic value of “1”, and the instruction is completed. The execution results for the instruction become in an invalid value. Consequently, the entry's WDATA flag becomes an invalid value, but if the logic value for that entry's W flag becomes “1”, the write back procedure to the register file 408b commences. Also, the instruction decode unit 401b, in accordance with the interrupt request from the reorder buffer 406b, begins an interrupt for an instruction that differs from the one that generated timeout.

As described above, according to the second embodiment of the present invention, it is possible to solve the critical bus problem by the decoding of one part of the user customizable instruction (DSP instruction) by the instruction decode unit 401b. Consequently, compared to the pipeline processor shown in FIG. 1, it is possible to support higher speed operations. Also, by generating an interrupt as a timeout process, it is possible to boost pipeline processor reliability a step further.

### Modification of Second Embodiment

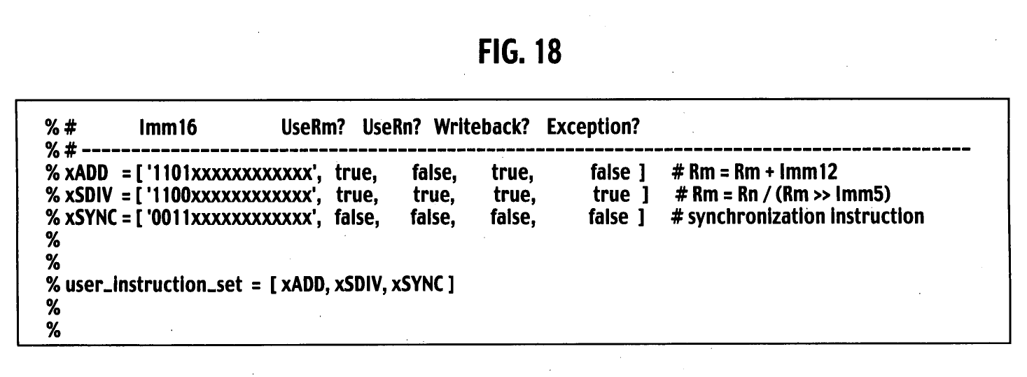

As for the Modification of the second embodiment of the present invention, following is a description of the method of process design for the pipeline processor in FIG. 17. The process procedure for the method for designing a processor is identical to that in FIG. 9, but the configuration information as shown in FIG. 18, and the meta hardware description as shown in FIG. 19 are used.

By using the configuration information as shown in FIG. 18, and the meta hardware description as shown in FIG. 19, it is possible to generate relevant hardware descriptions from the user instruction definition. The configuration information shown in FIG. 18, in accordance with the user customizable instruction specifications, describes the following (1) to (5) information. (1) The instruction decode for the user customizable instruction. (2) Whether there is an instruction using Operand Rm. (3) Whether there is an instruction using Operand Rn. (4) Whether there is an instruction performing write back. (5) Whether there is the possibility of exception generation.

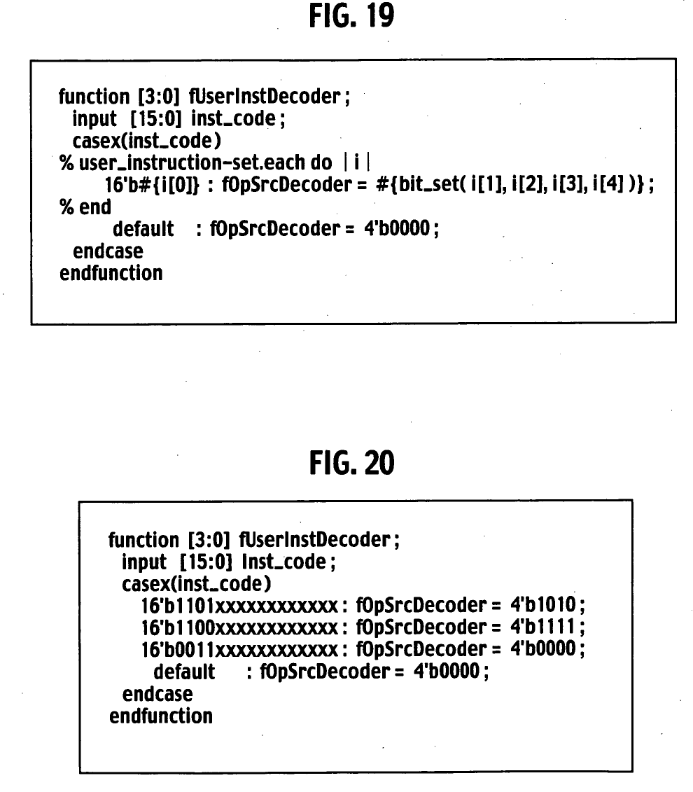

FIG. 18 gives an example of when an “ADD” instruction, “SDIV” instruction, and “SYNC” instruction are defined in the user customizable instruction. The “ADD” instruction indicates an add instruction, the “SDIV” instruction indicates a shift division instruction, and the “SYNC” instruction indicates a synchronous instruction. In the configuration information shown in FIG. 18, and the meta hardware description shown in FIG. 19, the hardware description shown in FIG. 20 is generated.

### OTHER EMBODIMENTS

Various modifications will become possible for those skilled in the art after receiving the teachings of the present disclosure without departing from the scope thereof.

In the aforementioned modification was a description of one exemplary usage of the DSP as the user customizable instruction units 402a and 402b, and of the DSP instruction as a user customizable instruction. However, it is acceptable to use, for example, a coprocessor as user customizable instruction units 402a and 402b.

Relating to the aforementioned Modification, it is acceptable to configure the pipeline processor as a reconfigurable processor. A “reconfigurable processor” indicates a processor where, by using the technique represented in field programmable gate array (FPGA), dynamic configuration of processor functions is possible. In order to design a reconfigurable processor, it is possible to use the same procedure as the processor design method relating to the aforementioned Modification.

What is claimed is:

1. A pipeline processor comprising:
an instruction decode unit configured to decode fetched instruction, and to selectively issue one of a user customizable instruction defined by a user and a core instruction;
a core instruction execution unit configured to execute the issued core instruction;
a user customizable instruction unit configured to execute the issued user customizable instruction; and
a reorder buffer configured to temporarily store instruction execution results of the core instruction execution unit and the user customizable instruction unit, and to reorder the instruction execution results in accordance with an order in which the core instruction and the user customizable instruction were issued.

2. The pipeline processor of claim 1, wherein the instruction decode unit decodes the core instruction when the fetched instruction is the core instruction, and decodes a part of the user customizable instruction when the fetched instruction is the user customizable instruction.

3. The pipeline processor of claim 2, wherein the instruction decode unit supplies at least one of a signal indicating whether the user customizable instruction uses an operand, and a signal indicating whether the user customizable instruction performs write back, by decoding the part of the user customizable instruction.

4. The pipeline processor of claim 1, wherein the reorder buffer discards an execution result of an instruction which generates an exception and an execution result for instructions issued after the instruction which generates the exception when the instruction execution result includes a signal notifying of a generation of the exception.

5. The pipeline processor of claim 1, further comprising a timeout controller configured to count clock cycles required for execution of the issued core instruction or the issued user customizable instruction, and to generate a timeout when a count result exceeds a fixed value.

6. The pipeline processor of claim 5, further comprising a register file including a plurality of registers,
wherein information indicating the generation of the timeout is stored in one of the registers.

7. The pipeline processor of claim 5, further comprising a register file including a plurality of registers,
wherein information indicating the fixed value is stored in one of the registers.

8. The pipeline processor of claim 5, wherein the reorder buffer determines that an exception is generated in an instruction that has become a target of the timeout when the timeout is generated.

9. The pipeline processor of claim 5, wherein the reorder buffer determines that an instruction that has become a target of the timeout is completed when the timeout is generated, and
the instruction decode unit interrupts the instruction by an instruction that differs from the instruction that has become the target of the timeout.

10. The pipeline processor of claim 1, wherein a digital signal processor or a coprocessor is used as the user customizable instruction unit.

11. The pipeline processor of claim 1, wherein the core instruction execution unit includes at least one of a floating point arithmetic unit, an integer instruction and branch instruction execution unit, and a load instruction and store instruction unit.

12. The pipeline processor of claim 1, wherein number of clock cycles required for execution of the issued user customizable instruction is variable.

13. A pipeline processor comprising:
an instruction decode unit configured to decode fetched instruction, and to issue an instruction;
an instruction execution unit configured to execute the issued instruction;
a reorder buffer configured to temporarily store instruction execution results of the instruction execution unit, and to reorder the instruction execution results in accordance with an order in which the instruction was issued; and
a timeout controller configured to count clock cycles required for execution of the issued instruction, and to generate a timeout when a count result exceeds a fixed value.

14. The pipeline processor of claim 13, wherein the reorder buffer determines that an exception is generated in an instruction that has become a target of the timeout when the timeout is generated.

15. The pipeline processor of claim 13, wherein the reorder buffer determines that an instruction that has become a target of the timeout is completed when the timeout is generated, and
the instruction decode unit interrupts the instruction by an instruction that differs from the instruction that has become the target of the timeout.

16. A method for automatically designing a pipeline processor including an instruction decode unit configured to decode fetched instruction, and to issue an instruction, an instruction execution unit configured to execute the issued instruction, and a reorder buffer configured to temporarily store instruction execution results of the instruction execution unit, and to reorder the instruction execution results in accordance with an order in which the instruction was issued, the method comprising:
acquiring a meta hardware description defining an arrangement and a function of the pipeline processor;
acquiring configuration information for adding or a removing hardware description regarding the meta hardware description; and
generating a hardware description for the pipeline processor from the meta hardware description in accordance with the configuration information.

17. The method of claim 16, further comprising:
executing a logic synthesis to the generated hardware description.

18. The method of claim 16, wherein the configuration information includes information for designating whether a user customizable instruction defined by a user is used or not.

19. The method of claim 18, wherein the configuration information includes at least one of an instruction code of the user customizable instruction, information indicating whether the user customizable instruction uses an operand, information indicating whether the user customizable instruction performs write back, and information indicating whether the user customizable instruction is capable of generating an exception.

20. The method of claim 18, wherein the configuration information includes information indicating whether the instruction decode unit decodes a part of the user customizable instruction.
